(19) United States
(12) Patent Application Publication
(10) Pub. No.: US 2023/0156854 A1
(43) Pub. Date: May 18, 2023

(54) NR SIDELINK DRX DESIGN FOR RELAY RESELECTION

(71) Applicant: QUALCOMM Incorporated, San Diego, CA (US)

(72) Inventors: Peng CHENG, Beijing (CN); Karthika PALADUGU, San Diego, CA (US); Wanshi CHEN, San Diego, CA (US); Hong CHENG, Basking Ridge, NJ (US); Gavin Bernard HORN, La Jolla, CA (US); Seyedkianoush HOSSEINI, San Diego, CA (US); Dan VASSILOVSKI, Del Mar, CA (US)

(21) Appl. No.: 17/907,596

(22) PCT Filed: May 17, 2020
(86) PCT No.: PCT/CN2020/090716

§ 371 Date: Sep. 28, 2022

(51) Int. Cl. H04W 76/28; H04W 8/00; H04W 24/10

(52) U.S. Cl. CPC H04W 76/28; H04W 8/005; H04W 24/10

(57) ABSTRACT

Certain aspects of the present disclosure provide techniques for switching between a first path and a second path when certain selection criteria are met. The first path may be a Uu connection whereby the remote UE is connected directly to a network entity. The second path may be a connection whereby the remote UE is connected to the network entity (i.e., indirectly) via a relay UE (e.g., by a PC5 connection).

### FIELD OF THE DISCLOSURE

Aspects of the present disclosure relate to wireless communications, and more particularly, to techniques for coordinating a sidelink discontinuous reception (DRX) mode for a remote UE connected to a relay.

### DESCRIPTION OF RELATED ART

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

In some examples, a wireless multiple-access communication system may include a number of base stations (BSs), which are each capable of simultaneously supporting communication for multiple communication devices, otherwise known as user equipments (UEs). In an LTE or LTE-A network, a set of one or more base stations may define an eNodeB (eNB). In other examples (e.g., in a next generation, a new radio (NR), or 5G network), a wireless multiple access communication system may include a number of distributed units (DUs) (e.g., edge units (EUs), edge nodes (ENs), radio heads (RHs), smart radio heads (SRHs), transmission reception points (TRPs), etc.) in communication with a number of central units (CUs) (e.g., central nodes (CNs), access node controllers (ANCs), etc.), where a set of one or more DUs, in communication with a CU, may define an access node (e.g., which may be referred to as a BS, 5G NB, next generation NodeB (gNB or gNodeB), transmission reception point (TRP), etc.). A BS or DU may communicate with a set of UEs on downlink channels (e.g., for transmissions from a BS or DU to a UE) and uplink channels (e.g., for transmissions from a UE to BS or DU).

These multiple access technologies have been adopted in various telecommunication standards to provide a common protocol that enables different wireless devices to communicate on a municipal, national, regional, and even global level. NR (e.g., new radio or 5G) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

Sidelink communications are communications from one UE to another UE. As the demand for mobile broadband access continues to increase, there exists a need for further improvements in NR and LTE technology, including improvements to sidelink communications. Preferably, these improvements should be applicable to other multi-access technologies and the telecommunication standards that employ these technologies.

### BRIEF SUMMARY

The systems, methods, and devices of the disclosure each have several aspects, no single one of which is solely responsible for its desirable attributes. Without limiting the scope of this disclosure as expressed by the claims that follow, some features will now be discussed briefly. After considering this discussion, and particularly after reading the section entitled “Detailed Description” one will understand how the features of this disclosure provide advantages that include improved communications between access points and stations in a wireless network.

Certain aspects provide a method for wireless communication by a remote user equipment (UE). The method generally includes connecting, via a sidelink, to a relay node connected to a network entity, sending an indication of a sidelink discontinuous reception (DRX) configuration preference, receiving, after sending the indication, a sidelink DRX configuration defining at least one sidelink DRX pattern, entering a reduced power state during off-durations of the sidelink DRX pattern; and monitoring for discovery messages from one or more other relays for relay selection, during on-durations of the sidelink DRX pattern

Certain aspects provide a method for wireless communication by a relay node. The method generally includes connecting, via a sidelink, to a remote user equipment (UE) while the relay node is also connected to a network entity, receiving, from the remote UE, an indication of a sidelink discontinuous reception (DRX) configuration preference, and sending to the remote UE, after receiving the indication, a sidelink DRX configuration defining at least one sidelink DRX pattern

Certain aspects provide a method for wireless communication by a network entity. The method generally includes connecting to a relay node that is connected to a remote user equipment (UE), receiving an indication of a sidelink discontinuous reception (DRX) configuration preference, and sending the remote UE, after receiving the indication, a sidelink DRX configuration defining at least one sidelink DRX pattern

Aspects generally include methods, apparatus, systems, computer readable mediums, and processing systems, as substantially described herein with reference to and as illustrated by the accompanying drawings.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example telecommunications system, in accordance with certain aspects of the present disclosure.

FIG. 2 is a block diagram illustrating an example logical architecture of a distributed radio access network (RAN), in accordance with certain aspects of the present disclosure.

FIG. 3 is a diagram illustrating an example physical architecture of a distributed RAN, in accordance with certain aspects of the present disclosure.

FIG. 4 is a block diagram conceptually illustrating a design of an example base station (BS) and user equipment (UE), in accordance with certain aspects of the present disclosure.

FIG. 5 is a high level path diagram illustrating example connection paths of a remote user equipment (UE), in accordance with certain aspects of the present disclosure.

FIG. 6 is an example block diagram illustrating a control plane protocol stack on L3, when there is no direct connection path between the remote UE and the network node, in accordance with certain aspects of the present disclosure.

FIG. 7 is an example block diagram illustrating a control plane protocol stack on L2, when there is direct connection path between the remote UE and the network node, in accordance with certain aspects of the present disclosure.

FIG. 8 illustrates example layer 3 (L3) relay procedures, in accordance with certain aspects of the present disclosure.

FIG. 9 illustrates example layer 2 (L2) relay procedures, in accordance with certain aspects of the present disclosure.

FIGS. 10A and 10B illustrate example relay discovery procedures.

FIG. 11 is a flow diagram illustrating example operations that may be performed by a remote UE, in accordance with certain aspects of the present disclosure.

FIG. 12 is a flow diagram illustrating example operations that may be performed by a relay UE, in accordance with certain aspects of the present disclosure.

FIG. 13 is a flow diagram illustrating example operations that may be performed by a network entity, in accordance with certain aspects of the present disclosure.

FIGS. 14-16 illustrate examples of sidelink DRX coordination, in accordance with certain aspects of the present disclosure.

FIG. 17 illustrates how a UE may be configured with a sidelink DRX for relay discovery for reselection, in accordance with certain aspects of the present disclosure.

FIG. 18 illustrates how a UE sidelink DRX configuration may be switched, in accordance with certain aspects of the present disclosure.

FIGS. 19A and 19B illustrate examples of DRX assisted fast relay selections, in accordance with certain aspects of the present disclosure.

FIG. 20 illustrates a communications device that may include various components configured to perform the operations illustrated in FIG. 11, in accordance with certain aspects of the present disclosure.

FIG. 21 illustrates a communications device that may include various components configured to perform the operations illustrated in FIG. 12, in accordance with certain aspects of the present disclosure.

FIG. 22 illustrates a communications device that may include various components configured to perform the operations illustrated in FIG. 13, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer readable mediums for coordinating a sidelink discontinuous reception (DRX) mode for a remote UE connected to a relay that is connected to a network entity (e.g., a gNB).

The connection between the relay and the network entity, may be called a Uu connection or via a Uu path. The connection between the remote UE and the relay (e.g., another UE or a “relay UE”), may be called a PC5 connection or via a PC5 path. The PC5 connection is a device-to-device connection that may take advantage of the comparative proximity between the remote UE and the relay UE (e.g., when the remote UE is closer to the relay UE than to the closest base station). The relay UE may connect to an infrastructure node (e.g., gNB) via a Uu connection and relay the Uu connection to the remote UE through the PC5 connection.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

The techniques described herein may be used for various wireless communication technologies, such as LTE, CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. Cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS).

New Radio (NR) is an emerging wireless communications technology under development in conjunction with the 5G Technology Forum (5GTF). 3GPP Long Term Evolution (LTE) and LTE-Advanced (LTE-A) are releases of UMTS that use E-UTRA. UTRA, E-UTRA, UMTS, LTE, LTE-A and GSM are described in documents from an organization named “3rd Generation Partnership Project” (3GPP). Cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, while aspects may be described herein using terminology commonly associated with 3G and/or 4G wireless technologies, aspects of the present disclosure can be applied in other generation-based communication systems, such as 5G and later, including NR technologies.

New radio (NR) access (e.g., 5G technology) may support various wireless communication services, such as enhanced mobile broadband (eMBB) targeting wide bandwidth (e.g., 80 MHz or beyond), millimeter wave (mmW) targeting high carrier frequency (e.g., 25 GHz or beyond), massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QoS) requirements. In addition, these services may co-exist in the same subframe.

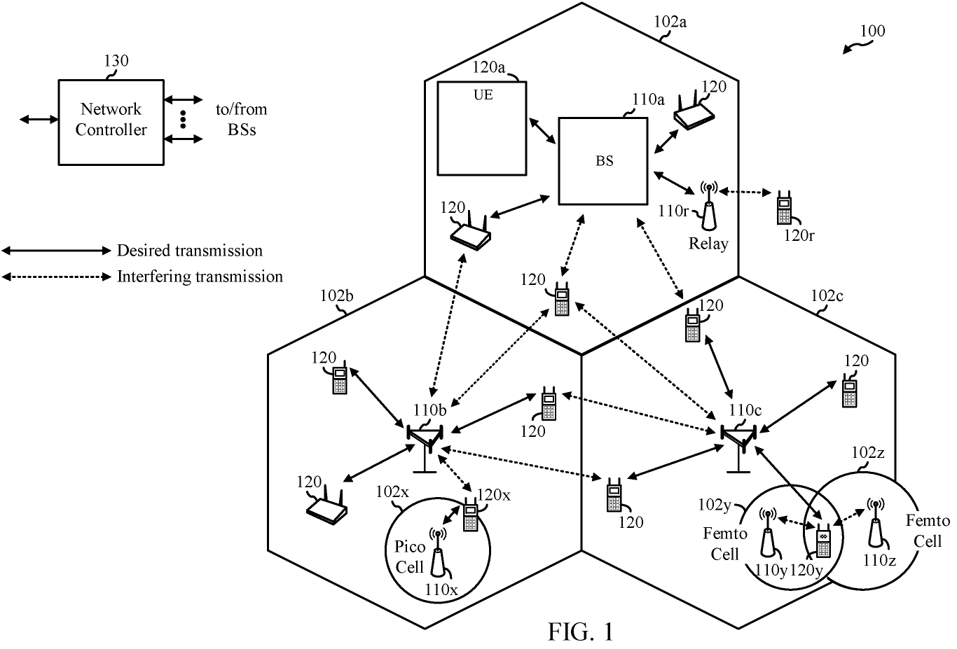

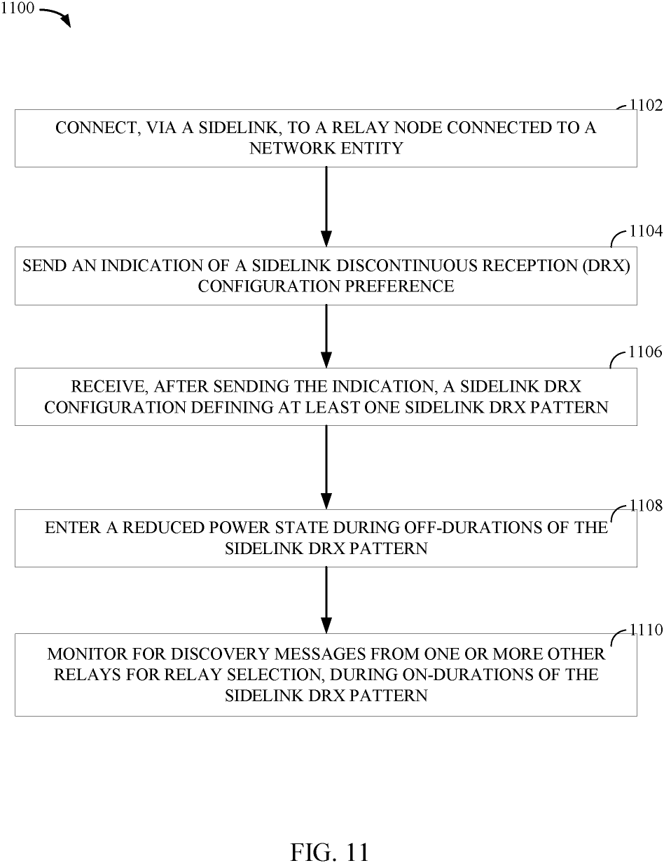

FIG. 1 illustrates an example wireless communication network 100 in which aspects of the present disclosure may be performed. For example, UEs 120a and/or BS 110a of FIG. 1 may be configured to perform operations 1100, 1200, and 1300 described below with reference to FIGS. 11, 12, and 13 to coordinate a remote UE sidelink DRX configuration.

As illustrated in FIG. 1, the wireless communication network 100 may include a number of base stations (BSs) 110a-z (each also individually referred to herein as BS 110 or collectively as BSs 110) and other network entities. In aspects of the present disclosure, a roadside service unit (RSU) may be considered a type of BS, and a BS 110 may be referred to as an RSU. A BS 110 may provide communication coverage for a particular geographic area, sometimes referred to as a “cell”, which may be stationary or may move according to the location of a mobile BS 110. In some examples, the BSs 110 may be interconnected to one another and/or to one or more other BSs or network nodes (not shown) in wireless communication network 100 through various types of backhaul interfaces (e.g., a direct physical connection, a wireless connection, a virtual network, or the like) using any suitable transport network. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. A BS may support one or multiple cells. The BSs 110 communicate with user equipment (UEs) 120a-y (each also individually referred to herein as UE 120 or collectively as UEs 120) in the wireless communication network 100. The UEs 120 (e.g., 120x, 120y, etc.) may be dispersed throughout the wireless communication network 100, and each UE 120 may be stationary or mobile.

Wireless communication network 100 may also include relay stations (e.g., relay station 110r), also referred to as relays or the like, that receive a transmission of data and/or other information from an upstream station (e.g., a BS 110a or a UE 120r) and sends a transmission of the data and/or other information to a downstream station (e.g., a UE 120 or a BS 110), or that relays transmissions between UEs 120, to facilitate communication between devices.

A network controller 130 may couple to a set of BSs 110 and provide coordination and control for these BSs 110. The network controller 130 may communicate with the BSs 110 via a backhaul. The BSs 110 may also communicate with one another (e.g., directly or indirectly) via wireless or wireline backhaul.

The UEs 120 (e.g., 120x, 120y, etc.) may be dispersed throughout the wireless communication network 100, and each UE may be stationary or mobile. A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block” (RB)) may be 12 subcarriers (or 180 kHz). Consequently, the nominal Fast Fourier Transfer (FFT) size may be equal to 128, 256, 512, 1024 or 2048 for system bandwidth of 1.25, 2.5, 5, 10, or 20 megahertz (MHz), respectively. The system bandwidth may also be partitioned into subbands. For example, a subband may cover 1.08 MHz (i.e., 6 resource blocks), and there may be 1, 2, 4, 8, or 16 subbands for system bandwidth of 1.25, 2.5, 5, 10 or 20 MHz, respectively.

While aspects of the examples described herein may be associated with LTE technologies, aspects of the present disclosure may be applicable with other wireless communications systems, such as NR. NR may utilize OFDM with a CP on the uplink and downlink and include support for half-duplex operation using TDD. Beamforming may be supported and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

In FIG. 1, a solid line with double arrows indicates desired transmissions between a UE and a serving BS, which is a BS designated to serve the UE on the downlink and/or uplink. A finely dashed line with double arrows indicates interfering transmissions between a UE and a BS.

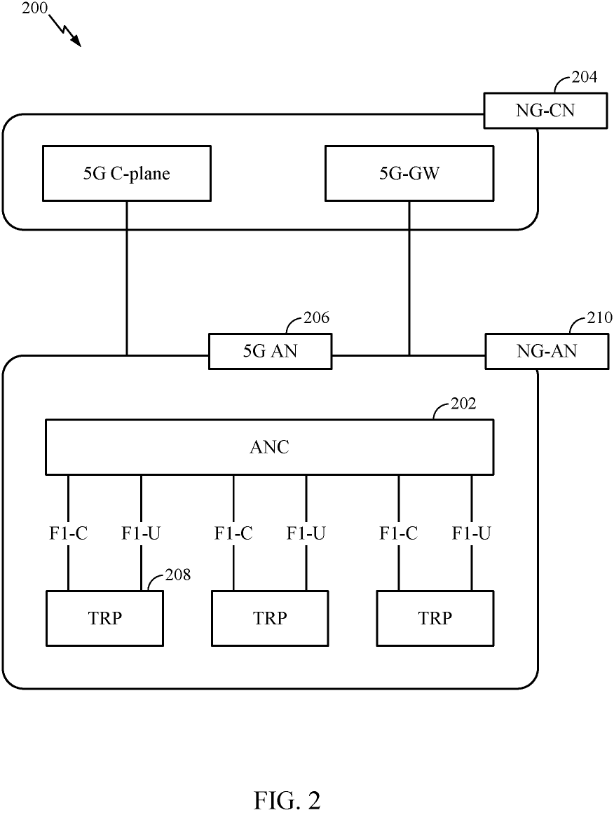

FIG. 2 illustrates an example logical architecture of a distributed Radio Access Network (RAN) 200, which may be implemented in the wireless communication network 100 illustrated in FIG. 1. A 5G access node 206 may include an access node controller (ANC) 202. ANC 202 may be a central unit (CU) of the distributed RAN 200. The backhaul interface to the Next Generation Core Network (NG-CN) 204 may terminate at ANC 202. The backhaul interface to neighboring next generation access Nodes (NG-ANs) 210 may terminate at ANC 202. ANC 202 may include one or more TRPs 208 (e.g., cells, BSs, gNBs, etc.).

The TRPs 208 may be a distributed unit (DU). TRPs 208 may be connected to a single ANC (e.g., ANC 202) or more than one ANC (not illustrated). For example, for RAN sharing, radio as a service (RaaS), and service specific AND deployments, TRPs 208 may be connected to more than one ANC. TRPs 208 may each include one or more antenna ports. TRPs 208 may be configured to individually (e.g., dynamic selection) or jointly (e.g., joint transmission) serve traffic to a UE.

The logical architecture of distributed RAN 200 may support fronthauling solutions across different deployment types. For example, the logical architecture may be based on transmit network capabilities (e.g., bandwidth, latency, and/or jitter).

The logical architecture of distributed RAN 200 may share features and/or components with LTE. For example, next generation access node (NG-AN) 210 may support dual connectivity with NR and may share a common fronthaul for LTE and NR.

The logical architecture of distributed RAN 200 may enable cooperation between and among TRPs 208, for example, within a TRP and/or across TRPs via ANC 202. An inter-TRP interface may not be used.

Logical functions may be dynamically distributed in the logical architecture of distributed RAN 200. The Radio Resource Control (RRC) layer, Packet Data Convergence Protocol (PDCP) layer, Radio Link Control (RLC) layer, Medium Access Control (MAC) layer, and a Physical (PHY) layers may be adaptably placed at the DU (e.g., TRP 208) or CU (e.g., ANC 202).

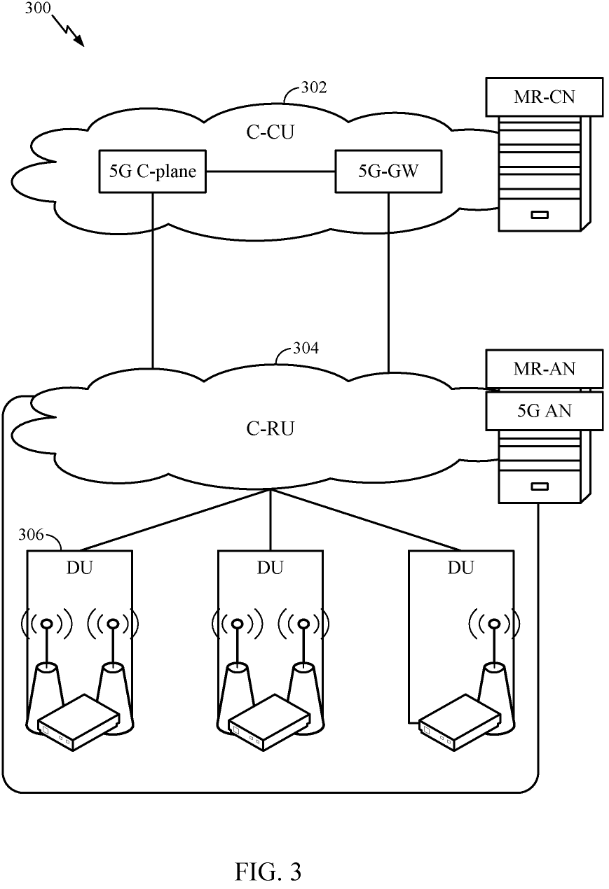

FIG. 3 illustrates an example physical architecture of a distributed RAN 300, according to aspects of the present disclosure. A centralized core network unit (C-CU) 302 may host core network functions. C-CU 302 may be centrally deployed. C-CU 302 functionality may be offloaded (e.g., to advanced wireless services (AWS)), in an effort to handle peak capacity.

A centralized RAN unit (C-RU) 304 may host one or more ANC functions. Optionally, the C-RU 304 may host core network functions locally. The C-RU 304 may have distributed deployment. The C-RU 304 may be close to the network edge.

A DU 306 may host one or more TRPs (Edge Node (EN), an Edge Unit (EU), a Radio Head (RH), a Smart Radio Head (SRH), or the like). The DU may be located at edges of the network with radio frequency (RF) functionality.

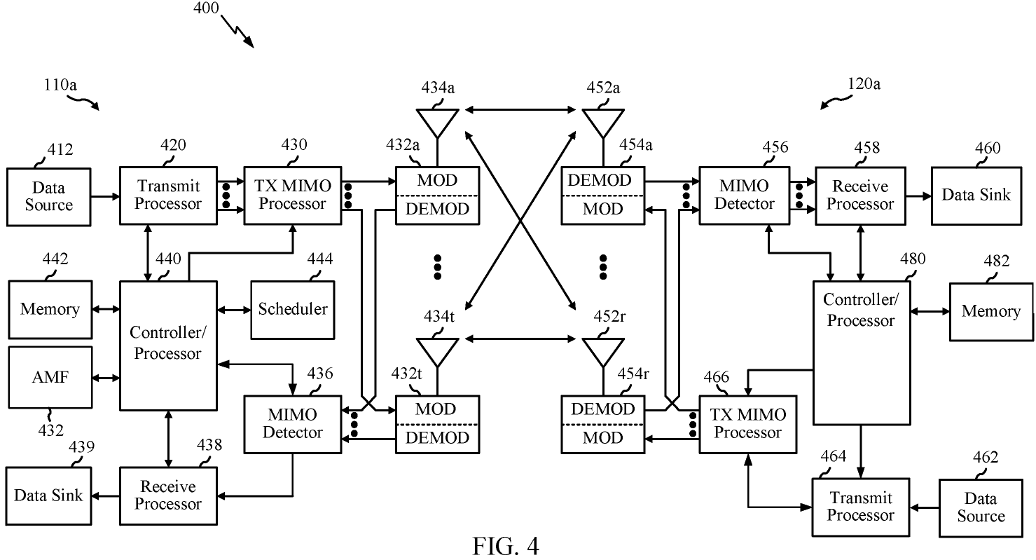

FIG. 4 illustrates example components of BS 110a and UE 120a (as depicted in FIG. 1), which may be used to implement aspects of the present disclosure. For example, antennas 452, processors 466, 458, 464, and/or controller/processor 480 of the UE 120a and/or antennas 434, processors 420, 430, 438, and/or controller/processor 440 of the BS 110a may be used to perform the various techniques and methods described herein with reference to FIGS. 11, 12, and 13.

At the BS 110a, a transmit processor 420 may receive data from a data source 412 and control information from a controller/processor 440. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. The processor 420 may process (e.g., encode and symbol map) the data and control information to obtain data symbols and control symbols, respectively. The processor 420 may also generate reference symbols, e.g., for the primary synchronization signal (PSS), secondary synchronization signal (SSS), and cell-specific reference signal (CRS). A transmit (TX) multiple-input multiple-output (MIMO) processor 430 may perform spatial processing (e.g., precoding) on the data symbols, the control symbols, and/or the reference symbols, if applicable, and may provide output symbol streams to the modulators (MODs) 432a through 432t. Each modulator 432 may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from modulators 432a through 432t may be transmitted via the antennas 434a through 434t, respectively.

At the UE 120a, the antennas 452a through 452r may receive the downlink signals from the base station 110a and may provide received signals to the demodulators (DEMODs) in transceivers 454a through 454r, respectively. Each demodulator 454 may condition (e.g., filter, amplify, downconvert, and digitize) a respective received signal to obtain input samples. Each demodulator may further process the input samples (e.g., for OFDM, etc.) to obtain received symbols. A MIMO detector 456 may obtain received symbols from all the demodulators 454a through 454r, perform MIMO detection on the received symbols if applicable, and provide detected symbols. A receive processor 458 may process (e.g., demodulate, deinterleave, and decode) the detected symbols, provide decoded data for the UE 120a to a data sink 460, and provide decoded control information to a controller/processor 480.

On the uplink, at UE 120a, a transmit processor 464 may receive and process data (e.g., for the physical uplink shared channel (PUSCH)) from a data source 462 and control information (e.g., for the physical uplink control channel (PUCCH) from the controller/processor 480. The transmit processor 464 may also generate reference symbols for a reference signal (e.g., for the sounding reference signal (SRS)). The symbols from the transmit processor 464 may be precoded by a TX MIMO processor 466 if applicable, further processed by the demodulators in transceivers 454a through 454r (e.g., for SC-FDM, etc.), and transmitted to the base station 110a. At the BS 110a, the uplink signals from the UE 120a may be received by the antennas 434, processed by the modulators 432, detected by a MIMO detector 436 if applicable, and further processed by a receive processor 438 to obtain decoded data and control information sent by the UE 120a. The receive processor 438 may provide the decoded data to a data sink 439 and the decoded control information to the controller/processor 440.

The controllers/processors 440 and 480 may direct the operation at the BS 110a and the UE 120a, respectively. The processor 440 and/or other processors and modules at the BS 110a may perform or direct the execution of processes for the techniques described herein with reference to FIGS. 11, 12, and 13.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks (WLANs), which typically use an unlicensed spectrum).

### Example UE to NW Relay

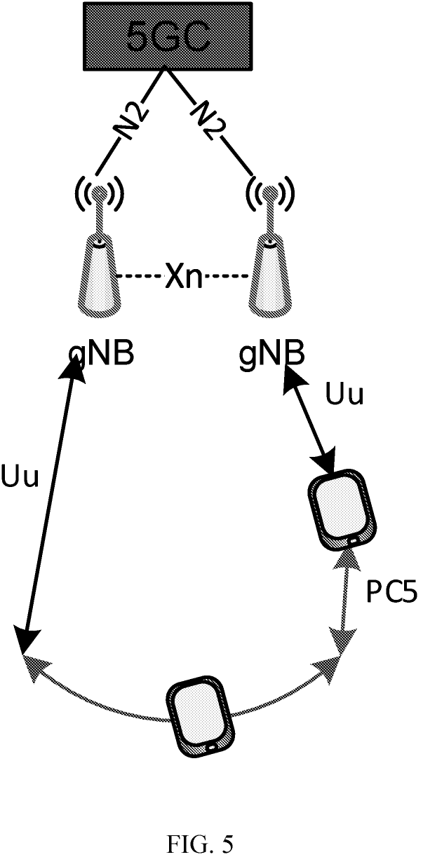

Aspects of the present disclosure involves a remote UE, a relay UE, and a network, as shown in FIG. 5, which is a high level path diagram illustrating example connection paths: a Uu path (cellular link) between a relay UE and the network gNB, a PC5 path (D2D link) between the remote UE and the relay UE. The remote UE and the relay UE may be in radio resource control (RRC) connected mode.

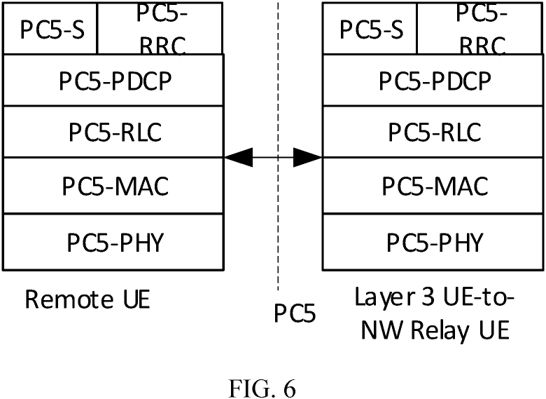

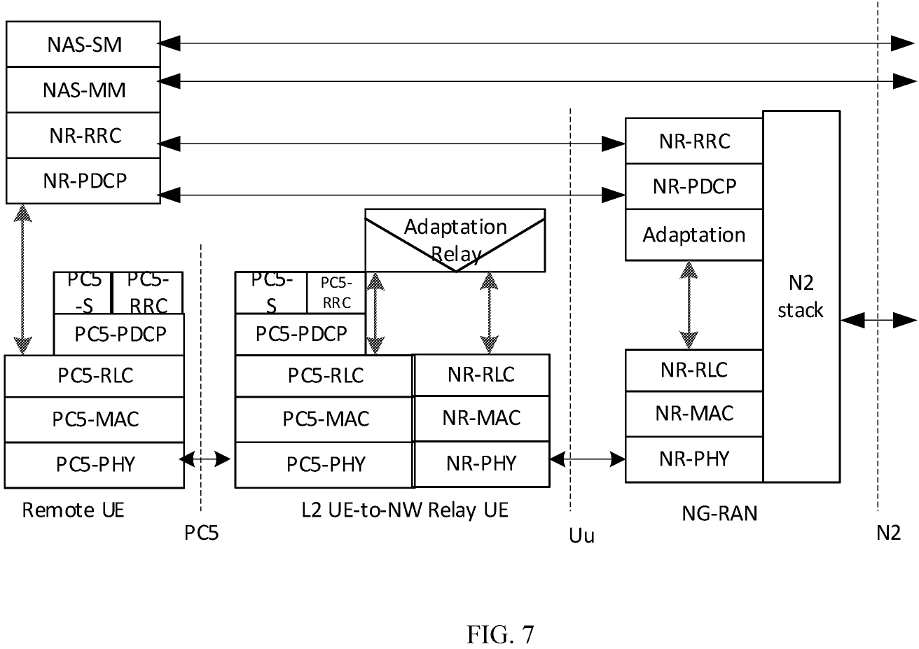

As shown in FIG. 6 and FIG. 7, remote UE may generally connect to a relay UE via a layer 3 (L3) connection with no Uu connection with (and no visibility to) the network or via a layer 2 (L2) connection where the UE supports Uu access stratum (AS) and non-AS connections (NAS) with the network.

FIG. 6 is an example block diagram illustrating a control plane protocol stack on L3, when there is no direct connection path (Uu connection) between the remote UE and the network node. In this situation, the remote UE does not have a Uu connection with a network and is connected to the relay UE via PC5 connection only (e.g., Layer 3 UE-to-NW). The PC5 unicast link setup may, in some implementations, be needed for the relay UE to serve the remote UE. The remote UE may not have a Uu application server (AS) connection with a radio access network (RAN) over the relay path. In other cases, the remote UE may not have direct none access stratum (NAS) connection with a 5G core network (5GC). The relay UE may report to the 5GC about the remote UE’s presence. Alternatively and optionally, the remote UE may be visible to the 5GC via a non-3GPP interworking function (N3IWF).

FIG. 7 is an example block diagram illustrating a control plane protocol stack on L2, when there is direct connection path between the remote UE and the network node. This control plane protocol stack refers to an L2 relay option based on NR-V2X connectivity. Both PC5 control plane (C-plane) and the NR Uu C-plane are on the remote UE, similar to what is illustrated in FIG. 6. The PC5 C-plane may set up the unicast link before relaying. The remote UE may support the NR Uu AS and NAS connections above the PC5 radio link control (RLC). The NG-RAN may control the remote UE’s PC5 link via NR radio resource control (RRC). In some embodiments, an adaptation layer may be needed to support multiplexing multiple UEs traffic on the relay UE’s Uu connections.

### Example NR Sidelink DRX Design for Relay Reselection

Certain systems, such as NR, may support standalone (SA) capability for sidelink-based UE-to-network and UE-to-UE relay communications, for example, utilizing layer-3 (L3) and layer-2 (L2) relays, as noted above.

Various procedures and functionalities may need to be supported in such systems. One example of such a procedure and functionality is relay selection and (re-)selection criteria and procedures. Aspects of the present disclosure provide a mechanism that may help support efficient operations of a discovery model/procedure for sidelink relaying, utilizing remote UE specific sidelink discontinuous reception (DRX) patterns.

Sidelink DRX modes may be used for broadcast, groupcast, and unicast operations. DRX configurations define on-durations and off-durations for sidelinks and specify the corresponding UE procedure. Aspects of the present disclosure may provide a mechanism that may help align sidelink DRX wake-up times among UEs (remote and relay UEs) communicating with each other and/or to align sidelink DRX wake-up times with Uu DRX wake-up times for in-coverage UEs.

In NR Rel-15, DRX mechanisms are similar to LTE DRX mechanisms. Both are MAC entities. But in LTE, the time units of DRX parameter are slots, while in NR time units are absolute time (ms). In NR, the hybrid automatic repeat request (HARQ) round trip time (RTT) timer starts after PUSCH transmission or PDSCH reception, while in LTE, this timer starts after PDCCH reception.

In Rel-16, various changes related to NR DRX were introduced. First, DRX configurations can be per frequency range (FR, such as FR1/FR2). Further, for power savings, a UE assistance information (UAI) was introduced on a preferred C-DRX configuration, which may include long DRX cycles, short DRX cycles, a DRX inactivity timer or, short DRX cycle timer. Further, wake up signals (WUS) were also introduced, for example, that indicate whether a UE should actually wake up during a DRX on duration.

Mechanisms may also be provided for relay selection and reselection. Relay selection generally refers the procedure whereby a remote UE has not connected to any relay node, discovers relay nodes whose sidelink discovery reference signal receive power (SD-RSRP) is above a threshold level (possibly by some amount) and, from among them, selects the relay node with best SD-RSRP. Relay re-selection generally refers the procedure whereby the remote UE has connected to one relay node (e.g., already performed relay selection), when SD-RSRP of the current relay node falls below a threshold level (possibly by some amount), the remote UE discovers relay nodes whose SD-RSRP is above a threshold level (possibly by some amount) and, among them, (re-)selects the relay node with the best SD-RSRP.

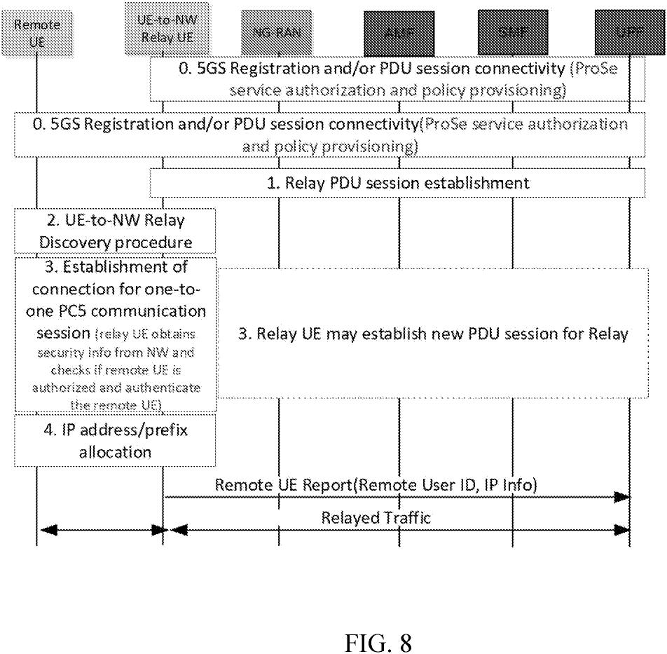

Particular relay procedures may depend on whether a relay is a L3 or L2 relay. FIG. 8 illustrates an example dedicated PDU session for an L3 relay. In the illustrated scenario, a remote UE establishes PC5-S unicast link setup and obtains an IP address. The PC5 unicast link AS configuration is managed using PC5-RRC. The relay UE and remote UE coordinate on the AS configuration. The relay UE may consider information from RAN to configure PC5 link. Authentication/authorization of the remote UE access to relaying may be done during PC5 link establishment. In the illustrated example, the relay UE performs L3 relaying.

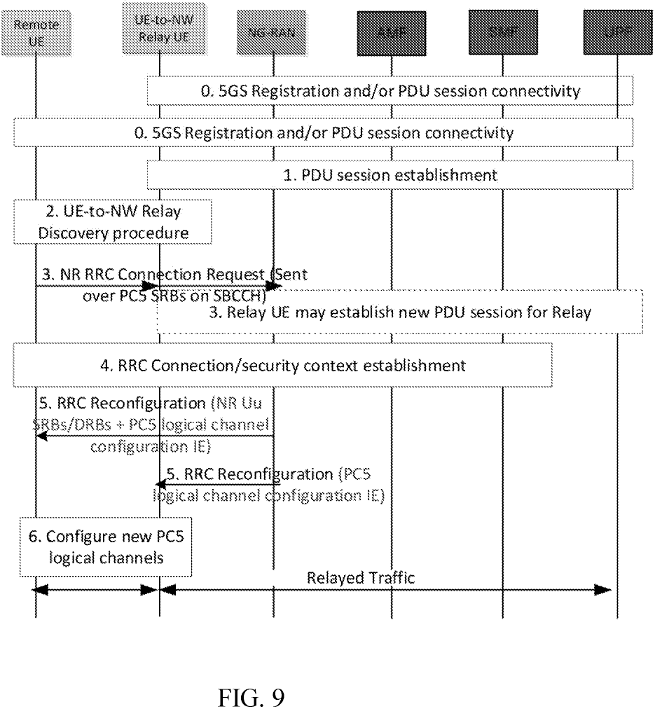

FIG. 9 illustrates an example dedicated PDU session for an L2 relay. In the illustrated scenario, there is no PC5 unicast link setup prior to relaying. The remote UE sends the NR RRC messages on PC5 signaling radio bearers (SRBs) over a sidelink broadcast control channel (SBCCH). The RAN can indicate the PC5 AS configuration to remote UE and relay UE independently via NR RRC messages. Changes may be made to NR V2X PC5 stack operation to support radio bearer handling in NR RRC/PDCP but support corresponding logical channels in PC5 link. In L2 relaying, PC5 RLC may need to support interacting with NR PDCP directly.

There are various issues to be addressed with sidelink relay DRX scenarios. One issue relates to support of a remote UE sidelink DRX for relay discovery. One assumption for relay discover in some cases is that the Relay UE is in CONNECTED mode only, rather than IDLE/INACTIVE. A remote UE, may be in a CONNECTED, IDLE/INACTIVE or out of coverage (OOC) modes.

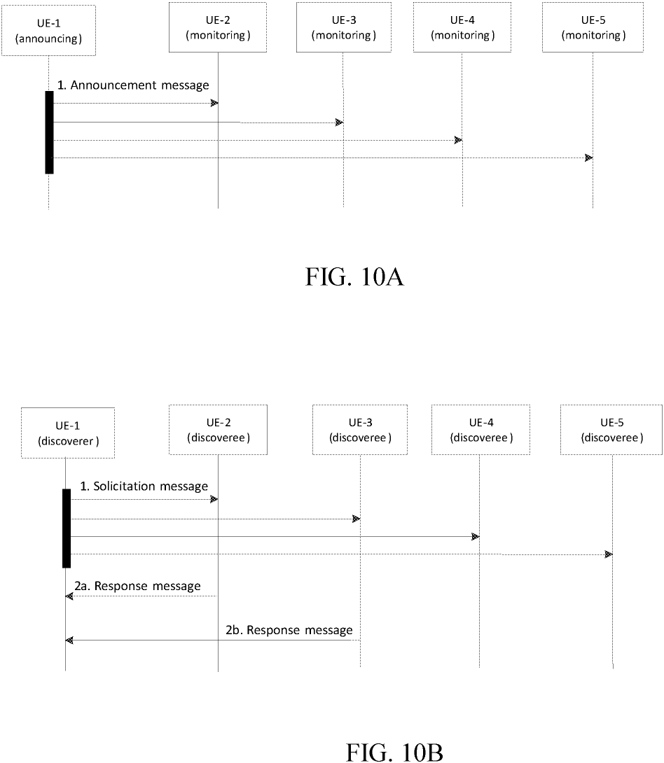

Discovery for both relay selection and reselection may be supported. Different type of discovery models may be supported. For example, a first model (referred to as Model A discovery) is shown in FIG. 10A. In this case, a UE sends discovery messages (an announcement) while other UEs monitor. According to a second model (referred to as Model B discovery) shown in FIG. 10B, a UE (discoverer) sends a solicitation message and waits for responses from monitoring UEs (discoverees). Such discovery messages may be sent on a PC5 communication channel (e.g., and not on separate discovery channel). Discovery messages may be carried within the same layer-2 frames as those used for other direct communication including, for example, the Destination Layer-2 ID that can be set to a unicast, groupcast or broadcast identifier, the Source Layer-2 ID that is always set to a unicast identifier of the transmitter, and the frame type indicates that it is a ProSe Direct Discovery message.

As noted above, for relay selection, the remote UE has not connected to any relay node (i.e. PC5 unicast link is not established between remote UE and relay node). In this case, it may be desirable to design DRX modes to reduce remote UE power consumption on monitoring relay discovery messages for relay selection.

As noted above, for relay reselection, the remote UE has connected to at least one relay node (e.g., with a PC5 unicast established between the emote UE and relay node). For relay reselection, it may be desirable to design a DRX configuration that helps reduce remote UE power consumption while monitoring for relay discovery messages for relay reselection and PC5 data transmission.

Aspects of the present disclosure may help achieve such DRX configurations for a remote UE, by coordinating with a relay that is connected to a network entity (e.g., a gNB) and/or the network entity itself. FIGS. 11, 12, and 13 illustrate example operations from the perspective of a remote UE, relay UE, and network entity, respectively, for coordinating a sidelink DRX configuration for a remote UE that may be optimized for relay reselection

FIG. 11 illustrates example operations 1100 that may be performed by a remote UE to coordinate a sidelink DRX configuration in accordance with aspects of the present disclosure. Operations 1100 may be performed, for example, by a UE 120 of FIG. 1 or FIG. 4.

Operations 1100 begin, at 1102, by connecting, via a sidelink, to a relay node connected to a network entity. At 1104, the remote UE sends an indication of a sidelink discontinuous reception (DRX) configuration preference. At 1106, the remote UE receives, after sending the indication, a sidelink DRX configuration defining at least one sidelink DRX pattern. At 1108, the remote UE entering a reduced power state during off-durations of the sidelink DRX pattern. At 1110, the remote UE monitors for discovery messages from one or more other relays for relay selection, during on-durations of the sidelink DRX pattern.

Operations 1200 may be performed by a relay node (e.g., a relay UE) to coordinate a sidelink DRX configuration for a remote UE (performing operations 1100 of FIG. 11).

Operations 1200 begin, at 1202, by connecting, via a sidelink, to a remote user equipment (UE) while the relay node is also connected to a network entity. At 1204, the relay node receives, from the remote UE, an indication of a sidelink discontinuous reception (DRX) configuration preference. At 1206, the relay node sends to the remote UE, after receiving the indication, a sidelink DRX configuration defining at least one sidelink DRX pattern.

Operations 1300 may be performed by a network entity (e.g., a gNB) connected to a relay node to coordinate a sidelink DRX configuration for a remote UE (performing operations 1100 of FIG. 11).

Operations 1300 begin, at 1302, by connecting to a relay node that is connected to a remote user equipment (UE). At 1304, the network entity receives an indication of a sidelink discontinuous reception (DRX) configuration preference. At 1306, the network entity sends the remote UE, after receiving the indication, a sidelink DRX configuration defining at least one sidelink DRX pattern.

As noted above, one of the objectives of the sidelink (SL) DRX configuration may be for power saving of the remote UE and/or the relay UE. Without SL DRX, the remote UE may have to keep its receiver always on to monitor for relay discovery messages. According to the SL DRX configuration, however, the relay UE may turn off its transceiver during sidelink DRX OFF durations for power saving

The SL DRX mode may be applied to relay reselection and PC5 data transmission (e.g., after connected to one relay node). As will be described in greater detail below, by coordinating with a remote UE, a remote UE specific sidelink DRX (e.g., similar to Uu C-DRX) pattern may be established.

For L3 relay scenarios, the remote UE may report its DRX preference (e.g., preferred parameters) to a relay node via PC5 RRC message. The relay node may decide the remote UE’s sidelink DRX configuration (e.g., according to the indicated preference or some other configuration). As an alternative, the relay node may forward the remote UE’s sidelink DRX preference to the network, for example, via a sidelink UE information (SUI) or UE assistance information (UAI), and the network entity may decide the remote UE SL DRX configuration.

For L2 relay scenarios, the remote UE can report its DRX preference directly to the network entity (e.g., via SUI or UAI), for the network entity to decide on its SL DRX configuration. In this case, the network entity can update both the remote UE and relay UE DRX configurations, for example, via RRC reconfiguration message

In either scenario (L3 or L2), if SL DRX is configured, the relay node may be required to send a sidelink broadcast channel (SL-BCH) for the synchronization of the remote UE SL DRX cycles.

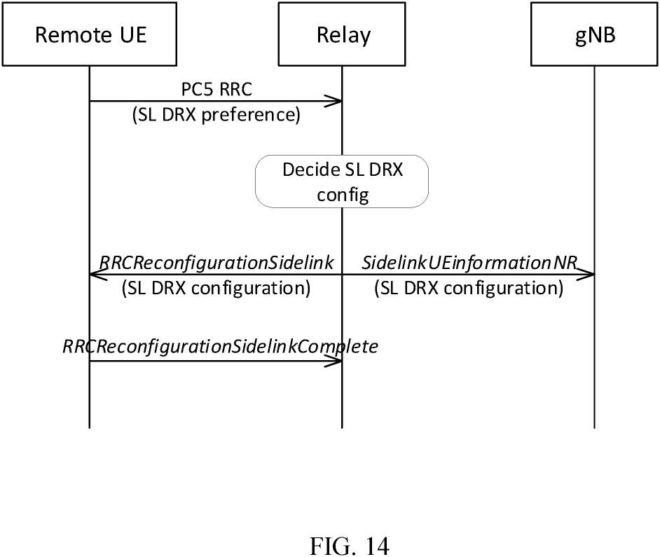

FIG. 14 illustrates one alternative for SL DRX configuration in an L3 relay scenario. As illustrated, the remote UE may indicate a specific (preferred) sidelink DRX configuration to the relay (e.g., via PC5 RRC). For example, the preferred sidelink DRX configuration may have DRX ON durations that are a subset of a remote UE group common DRX ON (e.g., used in relay selection). The indicated DRX preference may include DRX cycle, on-duration timer/offset, inactivity timer (same as legacy UAI).

As illustrated, in this alternative, the relay node decides the remote UE DRX pattern (e.g., according to the indication preference or otherwise). The relay node may convey the remote UE specific sidelink DRX, for example, via a PC5 RRC message. As illustrated, the relay node may also forward remote UE’s sidelink DRX configuration to the network, for example, via a SidelinkUEinformationNR (SUI).

The remote UE may apply the sidelink DRX configuration similar to a Uu C-DRX mode. For example, the remote UE may not monitor any receive resource pools which fall into the dedicated DRX off time. Further, at least the DRX inactivity timer may be running and possibly a HARQ RTT timer. In some cases, the remote UE may apply the dedicated sidelink DRX for all of its sidelinks (PC5 links). In other words, a single remote UE dedicated DRX configuration may apply to all of its PC5 links. This may be sufficient, as DRX configurations among different relay nodes (in CONNECTED mode) may be coordinated, for example, via inter-node messages.

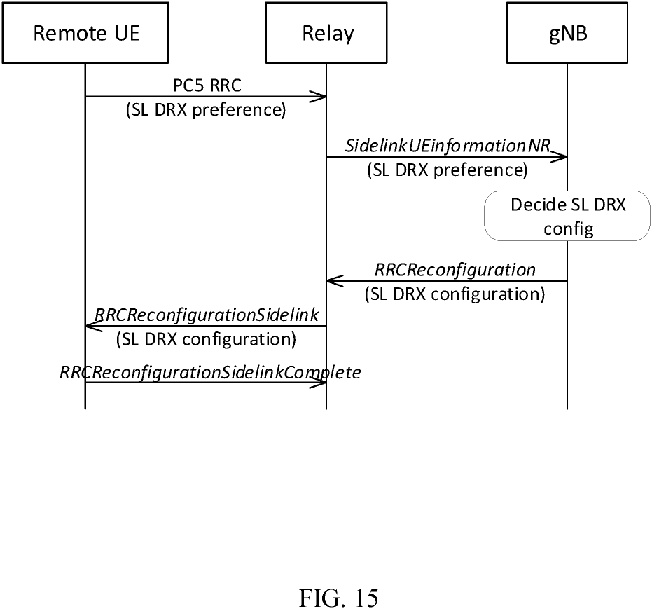

FIG. 15 illustrates another alternative for SL DRX configuration in an L3 relay scenario, in which the network entity decides the remote UE DRX pattern.

As in the example of FIG. 14, the remote UE may report its sidelink DRX preference to relay node via PC5 RRC message. But in this case, the relay node forwards remote UE’s sidelink DRX preference to NW via SidelinkUEinformationNR (SUI) or UEAssistencelnformation (UAI). The network entity decides remote UE specific sidelink DRX configuration, and sends it to relay node via RRC reconfiguration message. The relay node the forwards the sidelink DRX configuration to the remote UE (e.g., via a PC5 RRC message), and the remote UE applies the sidelink DRX as noted above.

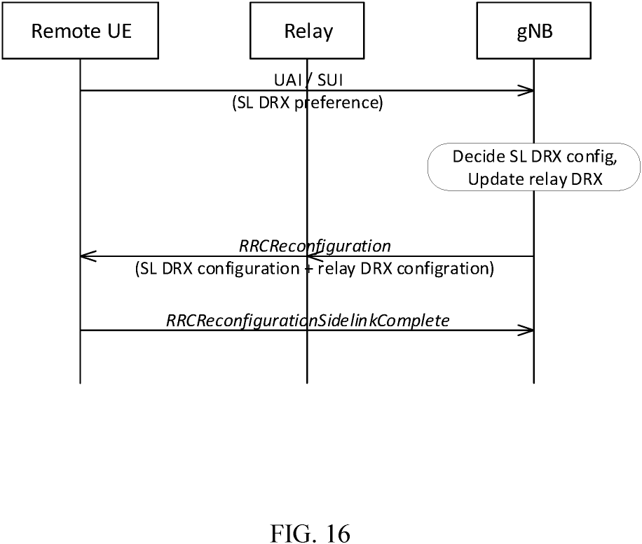

FIG. 16 illustrates an example of remote UE specific SL DRX configuration coordination in a scenario involving an L2 relay. In this scenario, it may always be up to the network to decide the remote UE DRX pattern.

As illustrated, in this case, the remote UE reports its sidelink DRX preference directly to the network entity (e.g., via UAI or SUI). As noted above, the DRX preference may include preferred settings for DRX cycle, on-duration timer/offset, inactivity timer.

The network entity decides the remote UE specific sidelink DRX configuration and, as illustrated, may also update relay UE DRX configuration. The network entity sends the DRX configuration to the remote UE (and possibly the relay node) via an RRC reconfiguration message. The remote UE may apply the new DRX configuration in the same manner as described above for the L3 relay scenarios.

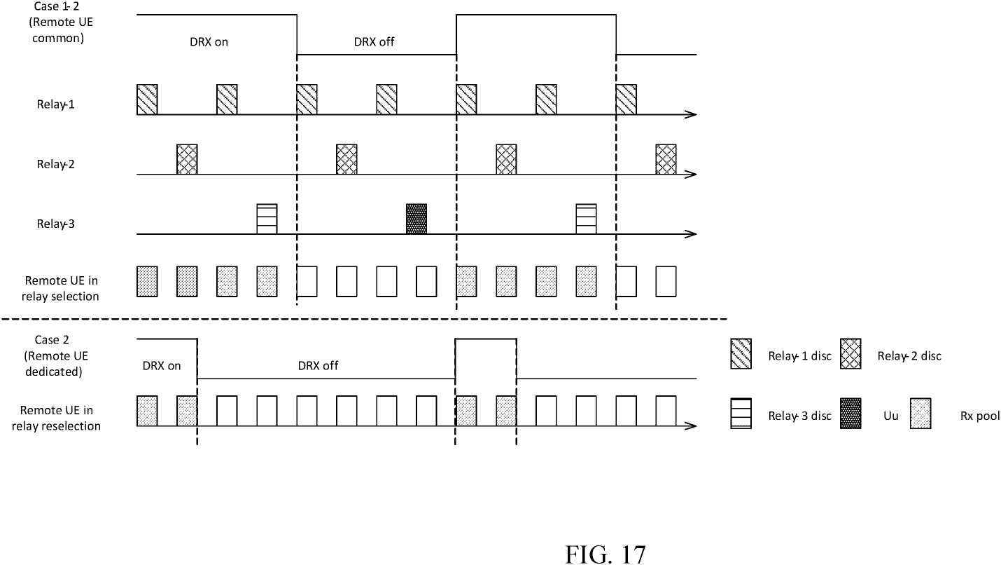

FIG. 17 illustrates a comparison of remote UE common DRX configuration (Case 1-2) and a remote UE specific (dedicated) sidelink DRX configuration (Case 2). As illustrated, before the UE has connected to a relay, it monitors for relay discovery messages for more relays, with a much longer DRX on duration for relay selection (e.g. to monitor for discovery messages from relay 1, relay 2, and relay 3).

Once the remote UE is connected to a relay UE, the remote UE can request (negotiate) a dedicated SL DRX. In the illustrated example, the remote UE connects to Relay-1, which sends the remote UE a dedicated SL DRX via PC5 RRC. As illustrated, the DRX pattern of the dedicated SL DRX may not require the remote UE to monitor for discovery messages from relay-3. Thus, the ON duration of the dedicated SL DRX cycle may be much shorter than the ON duration of the remote UE common DRX cycle, allowing the remote UE to stay powered down longer.

In addition to power savings, a remote UE SL DRX cycle may be optimized in other ways. For example, in some cases, once the remote UE is connected to a relay UE, the relay UE can adjust the DRX cycle of the Remote to assist the Remote UE to perform faster relay reselection.

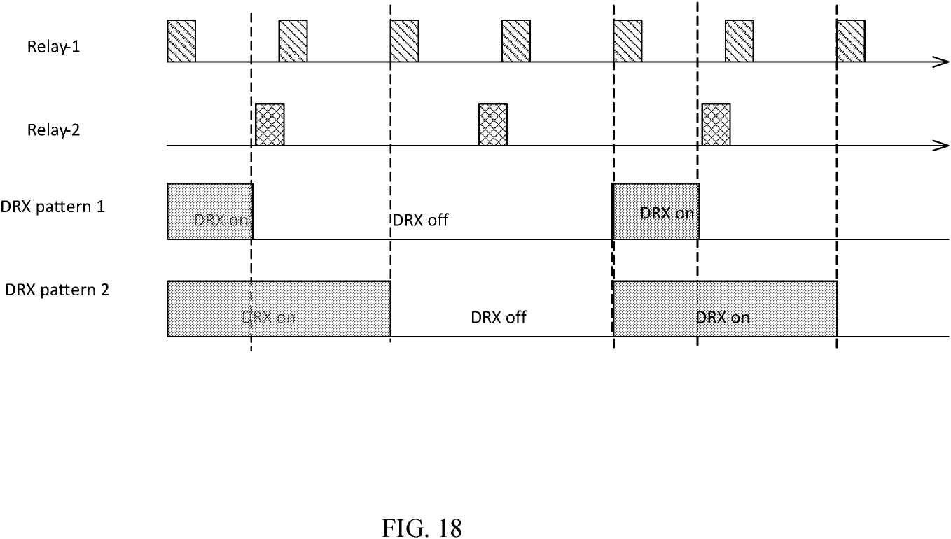

For example, as illustrated in FIG. 18, the remote UE may be configured to use a first SL DRX configuration (labeled DRX pattern 1) for use when the remote UE is experiencing good relay link quality (e.g., SL-RSRP is above certain threshold). When the relay link quality is below a certain threshold, however, the remote UE can switch (or be switched) to a second DRX configuration (labeled DRX pattern 2). As illustrated, DRX pattern 2 has a much larger DRX on duration, allowing the UE to monitor for more relay discovery signals thank DRX pattern 1 (e.g., DRX pattern 2 cover discovery signals from relay 2, while DRX pattern 1 does not).

There are various options for how to switch the remote UE from one SL DRX pattern to another. According to a first option, the remote UE makes this decision for itself (e.g., the remote UE autonomously switches DRX patterns). This option may apply to L2 or L3 relay scenarios.

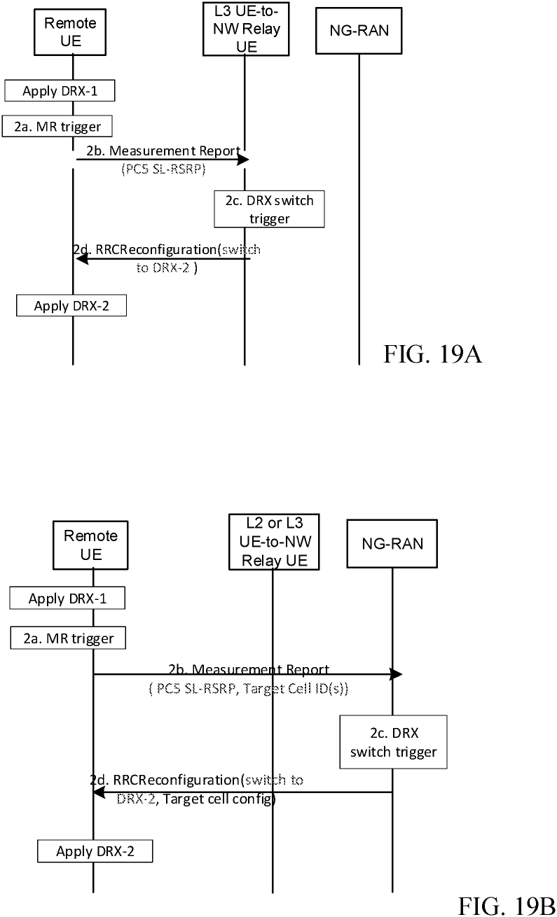

According to a second option, illustrated in FIG. 19A, the relay UE may decide to switch the remote UE to a different SL DRX pattern. As illustrated, the relay UE may decide based on Remote UE reported SL measurements. The relay UE may instruct the remote UE to switch to a different SL DRX pattern via an RRC reconfiguration message. This option generally may apply only to the L3 relay scenario.

According to a third option, illustrated in FIG. 19B, the network entity may decide to switch the remote UE to a different SL DRX pattern. As illustrated, the decision may be based on Remote UE reported SL measurements. The network entity may instruct the remote UE to switch to a different SL DRX pattern via an RRC reconfiguration message that may also indicate a target cell configuration. This option may be applied to L2 or L3 relay scenarios.

In some cases, in the remote UE may need to synchronize its timing for the SL DRX mode for relay discovery. For example, the remote UE common DRX may need timing synchronization among all the remote UEs and relay UEs. In this case, relay nodes may always be CONNECTED and, therefore, synchronized with gNB. The remote UE, on the other hand, may need synchronization. If the DRX is configured in SIB and/or pre-configured, the relay node may be required to send a sidelink broadcast channel (SL-BCH) for the synchronization of remote UE. In other words, the remote UE may be able to synchronize its timing and apply this to the DRX pattern ON and OFF durations.

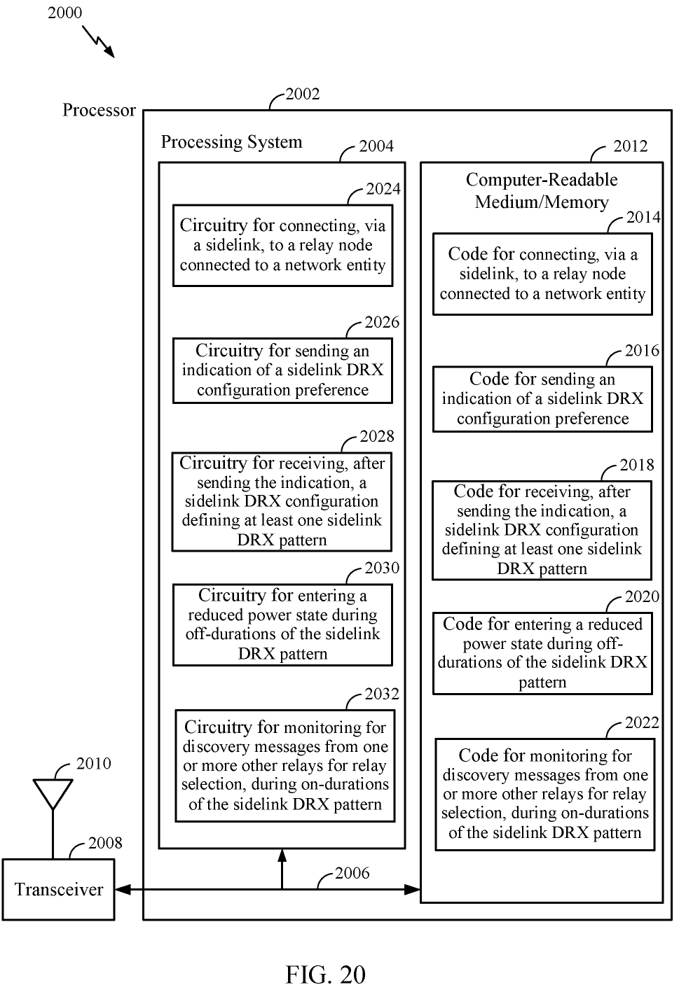

FIG. 20 illustrates a communications device 2000 that may include various components (e.g., corresponding to means-plus-function components) configured to perform operations for the techniques disclosed herein, such as the operations illustrated in FIG. 11. The communications device 2000 includes a processing system 2002 coupled to a transceiver 2008. The transceiver 2008 is configured to transmit and receive signals for the communications device 2000 via an antenna 2010, such as the various signals as described herein. The processing system 2002 may be configured to perform processing functions for the communications device 2000, including processing signals received and/or to be transmitted by the communications device 2000.

The processing system 2002 includes a processor 2004 coupled to a computer-readable medium/memory 2012 via a bus 2006. In certain aspects, the computer-readable medium/memory 2012 is configured to store instructions (e.g., computer-executable code) that when executed by the processor 2004, cause the processor 2004 to perform the operations illustrated in FIG. 11, or other operations for switching between a PC5 path and a Uu path. In certain aspects, computer-readable medium/memory 2012 stores code 2014 for connecting, via a sidelink, to a relay node connected to a network entity; code 2016 for sending an indication of a sidelink discontinuous reception (DRX) configuration preference; code 2018 for receiving, after sending the indication, a sidelink DRX configuration defining at least one sidelink DRX pattern; code 2020 for entering a reduced power state during off-durations of the sidelink DRX pattern; and code 2022 for monitoring for discovery messages from one or more other relays for relay selection, during on-durations of the sidelink DRX pattern. In certain aspects, the processor 2004 has circuitry configured to implement the code stored in the computer-readable medium/memory 2012. The processor 2004 includes circuitry 2024 for connecting, via a sidelink, to a relay node connected to a network entity; circuitry 2026 for sending an indication of a sidelink discontinuous reception (DRX) configuration preference; circuitry 2028 for receiving, after sending the indication, a sidelink DRX configuration defining at least one sidelink DRX pattern; circuitry 2030 for entering a reduced power state during off-durations of the sidelink DRX pattern; and circuitry 2032 for monitoring for discovery messages from one or more other relays for relay selection, during on-durations of the sidelink DRX pattern.

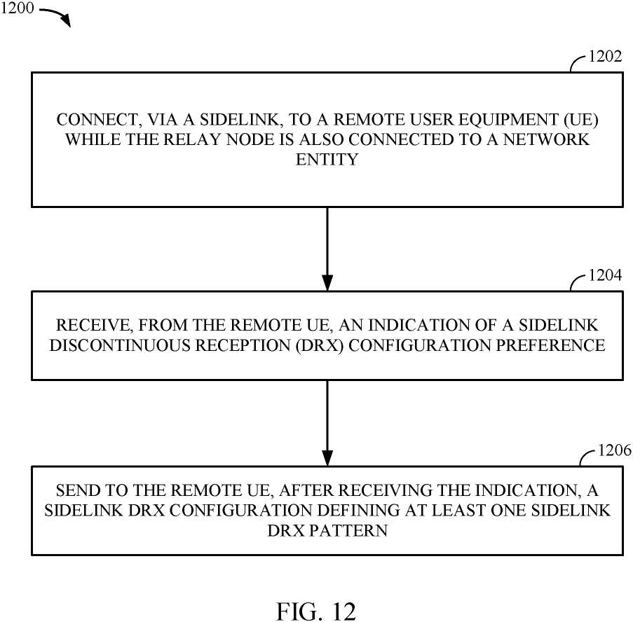

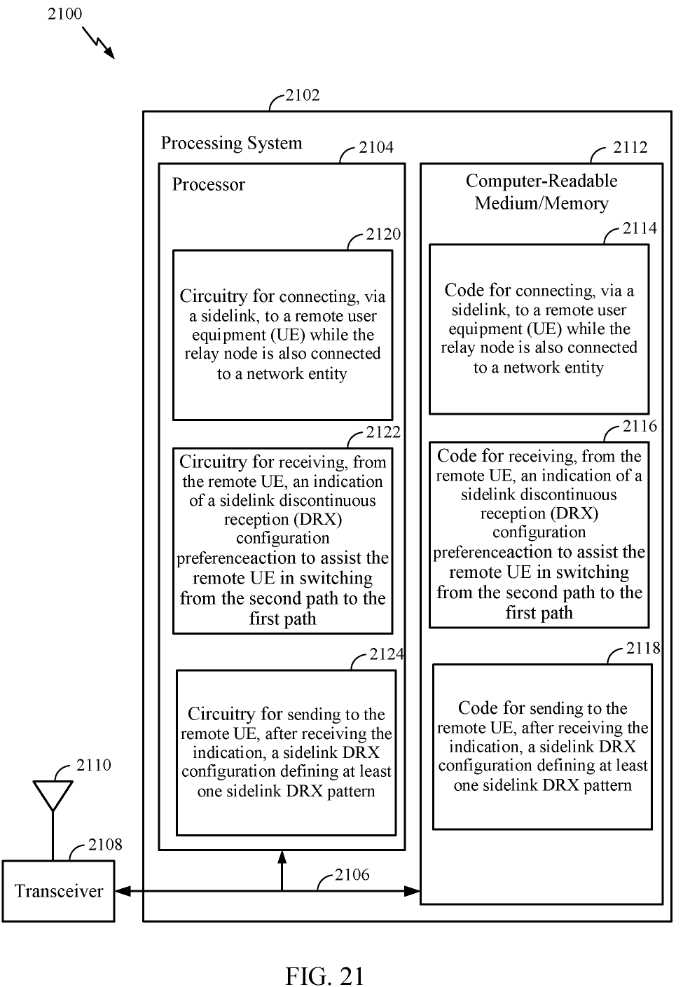

FIG. 21 illustrates a communications device 2100 that may include various components (e.g., corresponding to means-plus-function components) configured to perform operations for the techniques disclosed herein, such as the operations illustrated in FIG. 12. The communications device 2100 includes a processing system 2102 coupled to a transceiver 2108. The transceiver 2108 is configured to transmit and receive signals for the communications device 2100 via an antenna 2110, such as the various signals as described herein. The processing system 2102 may be configured to perform processing functions for the communications device 2100, including processing signals received and/or to be transmitted by the communications device 2100.

The processing system 2102 includes a processor 2104 coupled to a computer-readable medium/memory 2121 via a bus 2106. I n certain aspects, the computer-readable medium/memory 2112 is configured to store instructions (e.g., computer-executable code) that when executed by the processor 2104, cause the processor 2104 to perform the operations illustrated in FIG. 12 or other operations for assisting the remote UE in switching paths. In certain aspects, computer-readable medium/memory 2112 stores code 2114 for connecting, via a sidelink, to a remote user equipment (UE) while the relay node is also connected to a network entity; code 2116 for receiving, from the remote UE, an indication of a sidelink discontinuous reception (DRX) configuration preference; and code 2118 for sending to the remote UE, after receiving the indication, a sidelink DRX configuration defining at least one sidelink DRX pattern. In certain aspects, the processor 2104 has circuitry configured to implement the code stored in the computer-readable medium/memory 2112. The processor 2104 includes circuitry 2120 for connecting, via a sidelink, to a remote user equipment (UE) while the relay node is also connected to a network entity; circuitry 2122 for receiving, from the remote UE, an indication of a sidelink discontinuous reception (DRX) configuration preference; and circuitry 2124 for sending to the remote UE, after receiving the indication, a sidelink DRX configuration defining at least one sidelink DRX pattern.

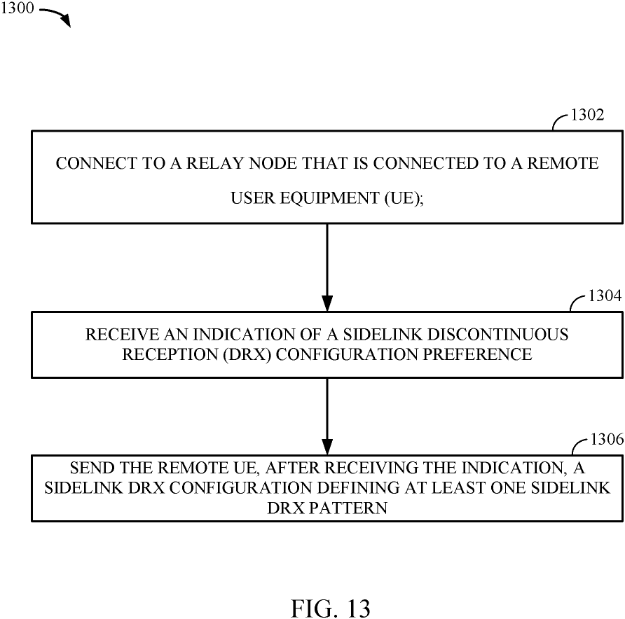

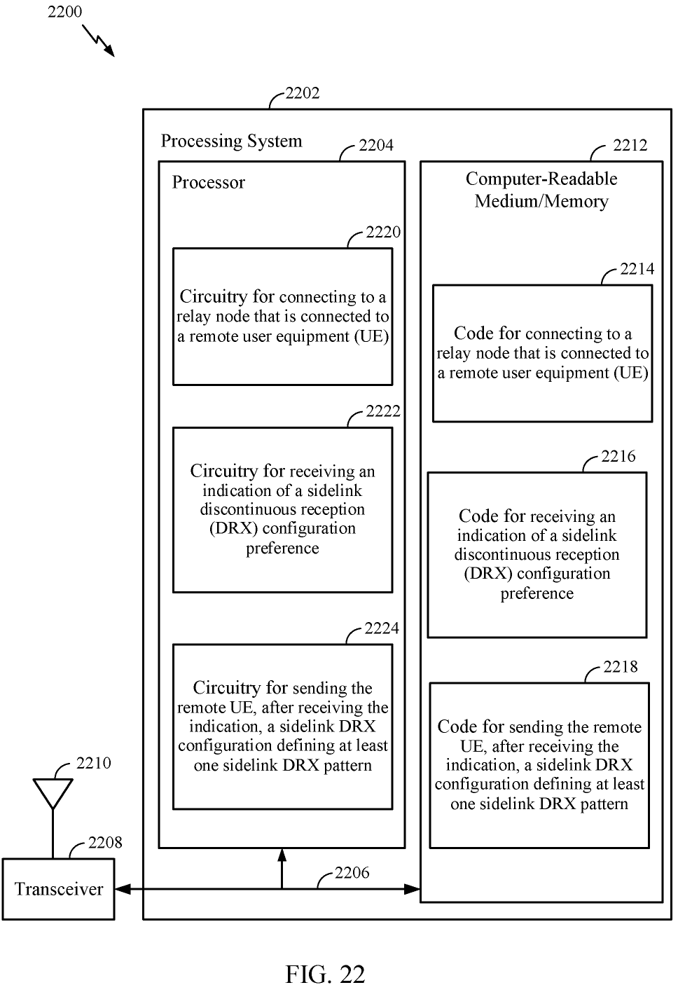

FIG. 22 illustrates a communications device 2200 that may include various components (e.g., corresponding to means-plus-function components) configured to perform operations for the techniques disclosed herein, such as the operations illustrated in FIG. 13. The communications device 2200 includes a processing system 2202 coupled to a transceiver 2208. The transceiver 2208 is configured to transmit and receive signals for the communications device 2200 via an antenna 2210, such as the various signals as described herein. The processing system 2202 may be configured to perform processing functions for the communications device 2200, including processing signals received and/or to be transmitted by the communications device 2200.

The processing system 2202 includes a processor 2204 coupled to a computer-readable medium/memory 2226 via a bus 2206. I n certain aspects, the computer-readable medium/memory 2212 is configured to store instructions (e.g., computer-executable code) that when executed by the processor 2204, cause the processor 2204 to perform the operations illustrated in FIG. 13 or other operations for assisting the remote UE with the switch between paths.

In certain aspects, computer-readable medium/memory 2212 stores code 2214 for connecting to a relay node that is connected to a remote user equipment (UE); code 2216 for receiving an indication of a sidelink discontinuous reception (DRX) configuration preference; and code 2218 for sending the remote UE, after receiving the indication, a sidelink DRX configuration defining at least one sidelink DRX pattern.

In certain aspects, the processor 2204 has circuitry configured to implement the code stored in the computer-readable medium/memory 2212. The processor 2204 includes circuitry 2220 for connecting to a relay node that is connected to a remote user equipment (UE); circuitry 2222 for receiving an indication of a sidelink discontinuous reception (DRX) configuration preference; and circuitry 2222 for sending the remote UE, after receiving the indication, a sidelink DRX configuration defining at least one sidelink DRX pattern.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components. For example, various operations shown in FIGS. 11, 12, and 13 may be performed by various processors shown in FIG. 4, such as processors 466, 458, 464, and/or controller/processor 480 of the UE 120a.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For example, instructions for performing the operations described herein and illustrated in FIGS. 11, 12, and 13.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. A method for wireless communication by a remote user equipment (UE), comprising:
connecting, via a sidelink, to a relay node connected to a network entity;
sending an indication of a sidelink discontinuous reception (DRX) configuration preference;
receiving, after sending the indication, a sidelink DRX configuration defining at least one sidelink DRX pattern;
entering a reduced power state during off-durations of the sidelink DRX pattern; and
monitoring for discovery messages from one or more other relays for relay selection, during on-durations of the sidelink DRX pattern.

2. The method of claim 1, wherein the on-duration of the sidelink DRX pattern comprises a subset of an on-duration remote UE group common DRX pattern on duration for initial relay selection.

3. The method of claim 1, wherein:
the remote UE sends the indication of the sidelink DRX configuration preference to the relay node; and
the relay node signals the sidelink DRX configuration to the remote UE.

4. The method of claim 3, wherein the relay node also decides the sidelink DRX pattern.

5. The method of claim 3, wherein:
the sidelink DRX configuration is signaled to the remote UE via a sidelink radio resource control (RRC) message; and
the remote UE does not monitor receive resource pools which fall into off durations of the sidelink DRX pattern.

6. The method of claim 5, wherein the remote UE applies the sidelink DRX pattern to all of its sidelinks.

7. The method of claim 3, wherein:
the relay node forwards the sidelink DRX configuration preference of the remote UE to the network entity; and
the network entity decides the sidelink DRX pattern and sends it to the relay node to be forwarded to the remote UE.

8. The method of claim 1, wherein:
the remote UE sends the indication of the sidelink DRX configuration preference to the network entity; and
the network entity decides the sidelink DRX pattern and signals the sidelink DRX configuration to the remote UE.

9. The method of claim 1, wherein:
the DRX configuration indicates at least first and second sidelink DRX patterns; and
the remote UE switches between the first and second sidelink DRX patterns based on one or more criteria.

10. The method of claim 9, wherein the one or more criteria relate to sidelink channel quality.

11. The method of claim 10, wherein the remote UE switches to a pattern with longer on durations when sidelink channel quality falls below a threshold.

12. The method of claim 11, wherein the remote UE decides autonomously to switch between the first and second DRX patterns.

13. The method of claim 11, wherein the relay node or network entity decides to switch the remote UE between the first and second DRX patterns based on sidelink measurements reported by the remote UE.

14. The method of claim 1, further comprising:
receiving a sidelink broadcast channel from the relay node; and
synchronizing timing of the DRX pattern based on the sidelink broadcast channel.

15. A method for wireless communication by a relay node, comprising:
connecting, via a sidelink, to a remote user equipment (UE) while the relay node is also connected to a network entity;
receiving, from the remote UE, an indication of a sidelink discontinuous reception (DRX) configuration preference; and
sending to the remote UE, after receiving the indication, a sidelink DRX configuration defining at least one sidelink DRX pattern.

16. The method of claim 15, wherein the on-duration of the sidelink DRX pattern comprises a subset of an on-duration remote UE group common DRX pattern on duration for initial relay selection.

17. The method of claim 15, wherein the relay node also decides the sidelink DRX pattern.

18. The method of claim 15, wherein:
the sidelink DRX configuration is signaled to the remote UE via a sidelink radio resource control (RRC) message.

19. The method of claim 15, wherein:
the relay node forwards the sidelink DRX configuration preference of the remote UE to the network entity; and
the network entity decides the sidelink DRX pattern and sends it to the relay node to be forwarded to the remote UE.

20. The method of claim 19, wherein the relay node forwards the sidelink DRX configuration preference of the remote UE to the network entity via at least one of sidelink UE information (SUI) or UE Assistance Information (UAI).

21. The method of claim 15, wherein:
the DRX configuration indicates at least first and second sidelink DRX patterns; and
the remote UE switches between the first and second sidelink DRX patterns based on one or more criteria.

22. The method of claim 21, wherein the one or more criteria relate to sidelink channel quality.

23. The method of claim 22, wherein the remote UE switches to a pattern with longer on durations when sidelink channel quality falls below a threshold.

24. The method of claim 23, wherein the remote UE decides autonomously to switch between the first and second DRX patterns.

25. The method of claim 23, wherein the relay node or network entity decides to switch the remote UE between the first and second DRX patterns based on sidelink measurements reported by the remote UE.

26. The method of claim 15, further comprising:
sending a sidelink broadcast channel, wherein the remote UE synchronizes timing of the DRX pattern based on the sidelink broadcast channel.

27. A method for wireless communication by a network entity, comprising:
connecting to a relay node that is connected to a remote user equipment (UE);
receiving an indication of a sidelink discontinuous reception (DRX) configuration preference; and
sending the remote UE, after receiving the indication, a sidelink DRX configuration defining at least one sidelink DRX pattern.

28. The method of claim 27, wherein the on-duration of the sidelink DRX pattern comprises a subset of an on-duration remote UE group common DRX pattern on duration for initial relay selection.

29. The method of claim 27, wherein:
the network entity receives the indication of the sidelink DRX configuration preference from the relay node; and
the network entity signals the sidelink DRX configuration to the remote UE via the relay node.

30. The method of claim 29, wherein the relay node forwards the sidelink DRX configuration preference of the remote UE to the network entity via at least one of sidelink UE information (SUI) or UE Assistance Information (UAI).

31. The method of claim 27, wherein:
the network entity receives the indication of the sidelink DRX configuration directly from the remote UE; and
the network entity decides the sidelink DRX pattern and signals the sidelink DRX configuration directly to the remote UE.

32. The method of claim 27, wherein:
the DRX configuration indicates at least first and second sidelink DRX patterns; and
the remote UE switches between the first and second sidelink DRX patterns based on one or more criteria.

33. The method of claim 32, wherein the one or more criteria relate to sidelink channel quality.

34. The method of claim 33, wherein the remote UE switches to a pattern with longer on durations when sidelink channel quality falls below a threshold.

35. The method of claim 34, wherein the remote UE decides autonomously to switch between the first and second DRX patterns.

36. (canceled)
